(19) United States
(12) Patent Application Publication
(10) Pub. No.: US 2013/0269107 A1
(43) Pub. Date: Oct. 17, 2013

(54) Bedding apparatus for use with a mattress, and method

(71) Applicant: Deborah J. Fiene, Grain Valley, MO (US)

(72) Inventor: Deborah J. Fiene, Grain Valley, MO (US)

(21) Appl. No.: 13/445,811

(22) Filed: Apr. 12, 2012

(51) Int. Cl. A47G 9/04; B68G 7/06; B23P 11/00

(52) U.S. Cl. 5/485; 5/497; 29/428; 29/91.1

(57) ABSTRACT

The disclosure sets forth and describes a bedding apparatus that is adapted for use in combination with a mattress; the disclosure also sets forth and describes a method of providing a bedding apparatus adapted for use in combination with a mattress. The apparatus includes a fitted sheet with a blanket attached to the fitted sheet. The blanket bears zipper teeth configured to mate with and removably connect the blanket to the fitted sheet.

### SUMMARY OF THE INVENTION

The invention is a bedding apparatus adapted for use in combination with a mattress; the invention is also a method of providing bedding for use with a mattress.

### The Inventive Apparatus

The inventive bedding apparatus includes a fitted sheet having a central portion configured to cover a top surface of the mattress. The fitted sheet will also have side wall portions configured to cover sides of the mattress. These side portions depend in a general downward direction from the top surface of the mattress and terminate at a lower edge of the mattress. The fitted sheet also has an elastic edge defining the periphery, the elastic edge having a channel containing an elastic band. When installed over a mattress, the elastic band engages a lower surface of the mattress.

The invention also includes a blanket attached to the fitted sheet. Each blanket edge extends beyond the central portion of the fitted sheet such that at least a portion of the blanket is positioned adjacent the side portions of the mattress when the fitted sheet envelopes the mattress. A zipper connects the blanket to the fitted sheet. This zipper has an initial portion positioned on the fitted sheet, preferably along side walls of the fitted sheet. The zipper also has a mating portion connected to the blanket, enabling the blanket and fitted sheet to be zipped together.

In a preferred embodiment of the invention, the bedding apparatus will include a skirt attached to the fitted sheet. In a preferred embodiment, the initial portion of the zipper is positioned on the fitted sheet and adjacent an upper hem of the skirt, which is also attached to the side wall of the fitted sheet when the fitted sheet snugly envelops a mattress.

### The Inventive Method

The invention is also a method of providing bed covering for a mattress. The method requires one to provide a mattress having a top surface, a bottom surface generally parallel the top surface and set apart therefrom by side walls depending downwardly from edges of the top surface. The method also requires the step of providing a fitted sheet configured to envelop the top surface and side walls of the mattress, the fitted sheet also having an elastic edge with a channel containing an elastic band; wherein the elastic band is configured to engage a lower surface of the mattress.

One must also attach a blanket to the fitted sheet. One should configure each blanket edge to extend beyond the central portion of the fitted sheet such that at least a portion of the blanket is positioned adjacent the side portions of the mattress when the fitted sheet envelopes the mattress.

The method also requires the step of connecting the blanket to the fitted sheet using a zipper. The zipper has an initial portion connected to side wall portions of the fitted sheet, and a mating portion positioned adjacent edges of the blanket.

In a preferred embodiment of the method, the invention will include the additional step of attaching a skirt to the fitted sheet. In this embodiment, the invention includes the step of positioning an upper hem of the skirt adjacent the initial portion of the zipper, which is positioned side walls on the fitted sheet. This embodiment also includes the step of positioning a mating portion of the zipper adjacent edges of the blanket.

Other objects, advantages and novel features of the present invention will become apparent from the following detailed description of the invention when considered in conjunction with the accompanying drawings

### BRIEF DESCRIPTION OF THE DRAWINGS

FIG. 1 is an exploded and perspective view showing unassembled parts of the inventive apparatus, according to the principles of the invention.

FIG. 2 is a perspective and cross-sectional view showing the inventive apparatus, according to the principles of the invention

FIG. 3 is a perspective view of showing the invention in combination with a standard mattress, shown with the blanket partly unzipped.

FIG. 4 is a comparative perspective view of the invention in combination with a standard mattress, shown with the blanket fully zipped.

FIG. 5 is a perspective view of a preferred embodiment of the invention.

### DETAILED DESCRIPTION OF THE PREFERRED EMBODIMENTS

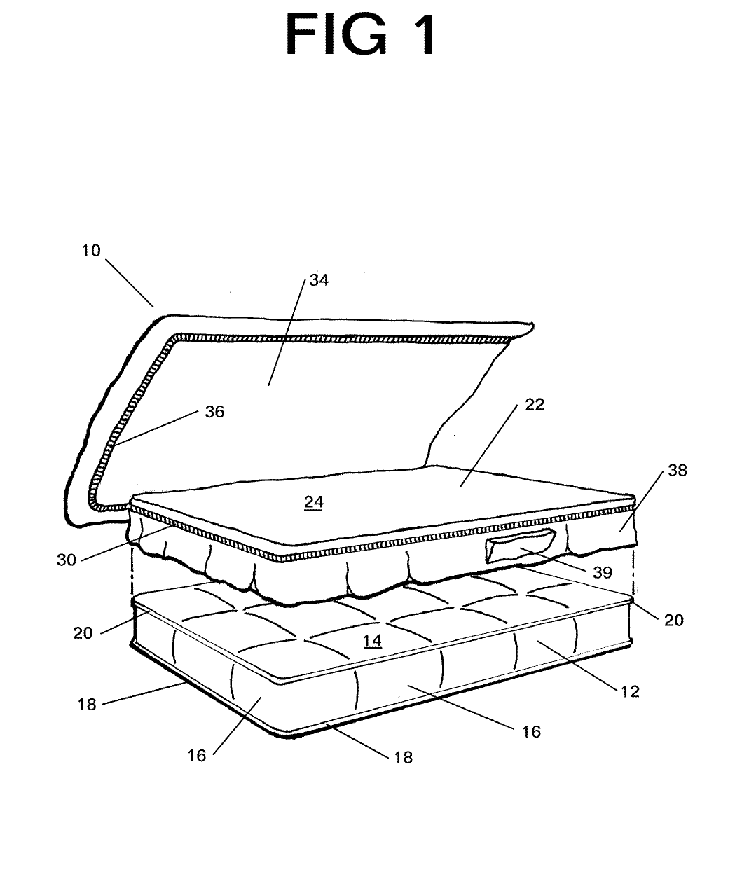

FIG. 1 presents an exploded and perspective view that details the parts of the inventive apparatus 10, according to the principles of the invention disclosed herein. The apparatus 10 is well-suited be used in combination with a mattress 12 having a top surface 14 and sides 16 that depend downwardly from an upper edge 20 down to a lower edge 18.

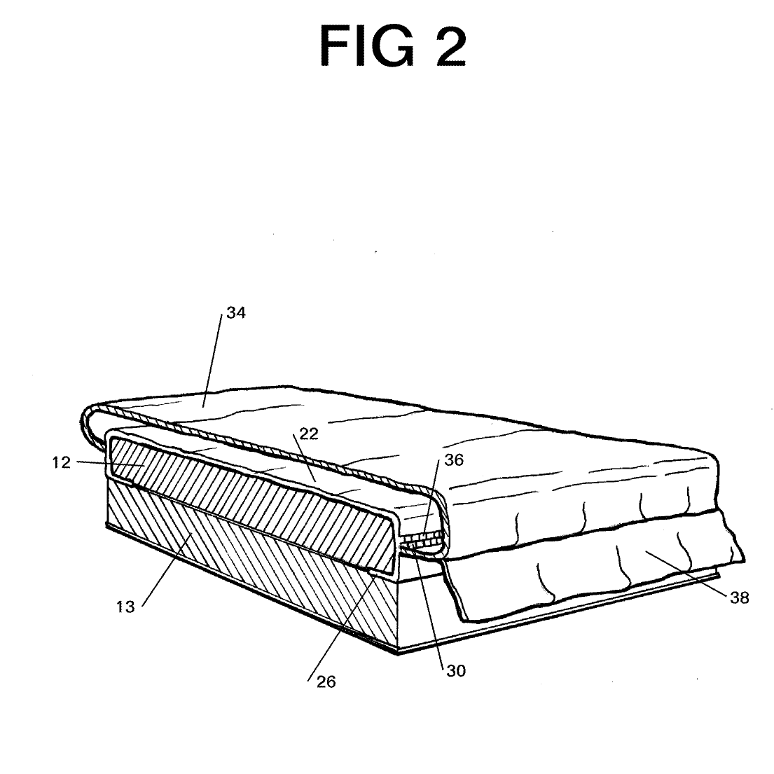

Still referring to FIG. 1, the invention will also include a fitted sheet 22 having a central portion 24 that is configured to cover the top surface 14 of the mattress 12. The fitted sheet 22 will also have an elastic band through a channel that defines its elastic edge 26 (not viewable in FIG. 1, but viewable in FIG. 2). The fitted sheet 22 is equipped with an initial portion of a zipper 30. The initial portion of the zipper 30 is positioned on the fitted sheet 22 such that it will be adjacent a side 16 of the mattress 12 when the fitted sheet 22 snugly envelops the mattress.

FIG. 1 also depicts a blanket 34 attached to the fitted sheet 22. As shown, a mating portion of the zipper 36 is attached to the blanket 34 adjacent the edges of the blanket 34. The blanket 34 may be selectively attached to the fitted sheet 22 by zipping the initial portion of the zipper 30 (which is on the fitted sheet 22) onto the mating portion of the zipper 36 (which is on the blanket 34).

Still referring to FIG. 1, the invention may also include a skirt 38. The skirt 38 is formed to depend downwardly from a location adjacent the lower edge 18 of the mattress 12 when the skirt 38 is attached to the fitted sheet 22. In that regard, the skirt 38 attaches to the fitted sheet 22, preferably by attaching the upper hem of the skirt 38 adjacent the zipper 30, and in turn attaching the zipper to the fitted sheet 22. Optionally, a pouch 39 may be attached to the skirt 38. This pouch 39 allows one to store personal items (ie., a television remote, a phone) near a sleeper's reach.

FIG. 2 details a cross-sectioned and perspective view of the apparatus 10 and its component parts. As shown, a mattress 12 sits atop a box springs 13 (or bed frame), and the fitted sheet 22 is formed to envelop the mattress 12. Attached to the fitted sheet 22 is an initial portion of a zipper 30, which is depicted meshed with the mating portion of the zipper 36 that is positioned adjacent an edge of the blanket 34.

As shown in FIG. 2, the fitted sheet 22 fits snugly around the mattress 12 such that the elastic edge 26 engages the lower surface of the mattress and is wedged between the mattress 12 and the box springs 13. Although the fitted sheet 22 should fit snugly around the mattress 12, the blanket 34 should be much larger and wider than the fitted sheet 22 and should leave room to extend beyond the edges of the mattress 12. This additional space is necessary in order to allow one to sleep between the fitted sheet 22 and the blanket 34.

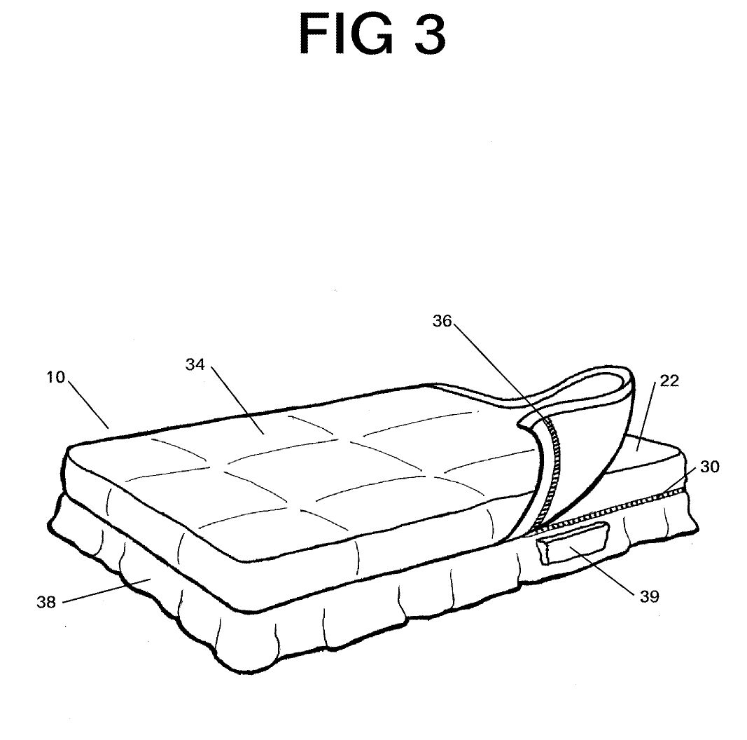

FIG. 3 shows a perspective view of the apparatus 10, according to the principles of the invention. The apparatus 10 includes a fitted sheet 22 attached to a blanket 34. As shown, the upper hem of the skirt 38 attaches to an initial portion of a zipper 30, which is also attached to the fitted sheet 22. Edges of the blanket 34 include a mating portion of a zipper 36 so that the blanket 34 can be attached to the sheet 22 at a location along a side wall of a mattress (see FIG. 1).

Still referring to FIG. 3, the skirt 38 may bear least one pouch 39, preferably positioned within reach of a sleeper. The pouch 39 may be used to stow a remote (as shown) or other personal items such as keys, a wallet, or a phone.

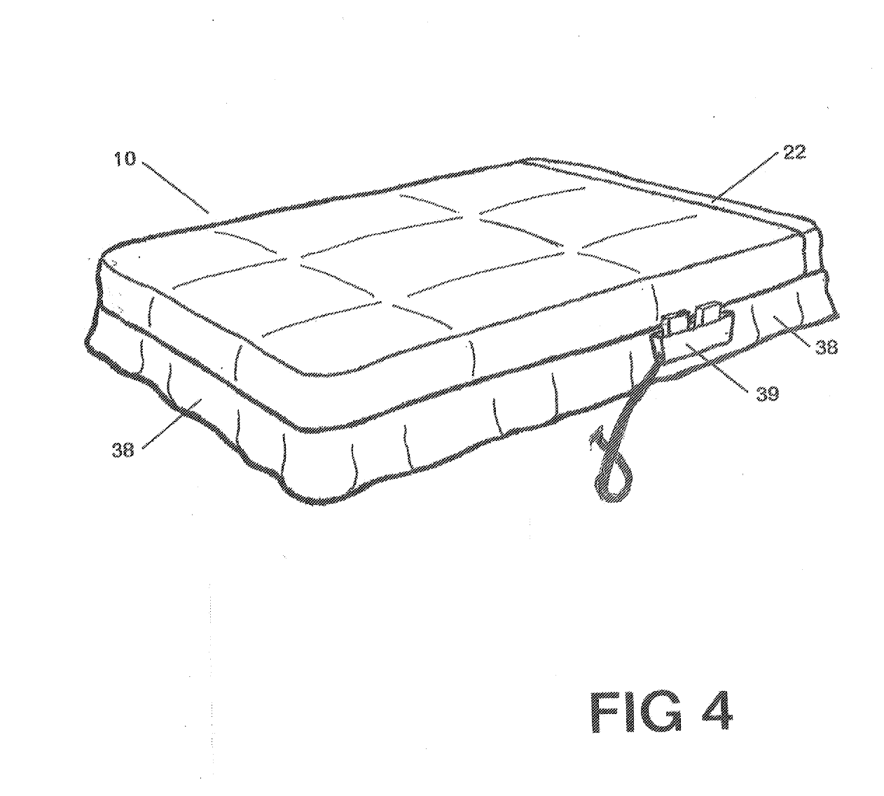

FIG. 4 shows a perspective view of the apparatus 10 as in FIG. 3, except shown in the bed-made condition. In the bed-made condition, the blanket 34 covers most of the fitted sheet 22; in a preferred embodiment, the blanket 34 may leave a small portion of the fitted sheet 22 uncovered, but this is obviously not required. In the bed-made condition shown in FIG. 4, edges of the blanket 34 will drape downwardly over the side portions of the mattress, and will also cover the upper hem of the skirt 38, and will also obscure the zipper from view as well. The pouch 39 is positioned on the skirt 38 at a portion near the head of the mattress and preferably within grasp of one positioned on the bed. In this embodiment, the pouch 39 may bear a hole that allows a cord to pass through so that one may stow electronic devices that need to be plugged in.

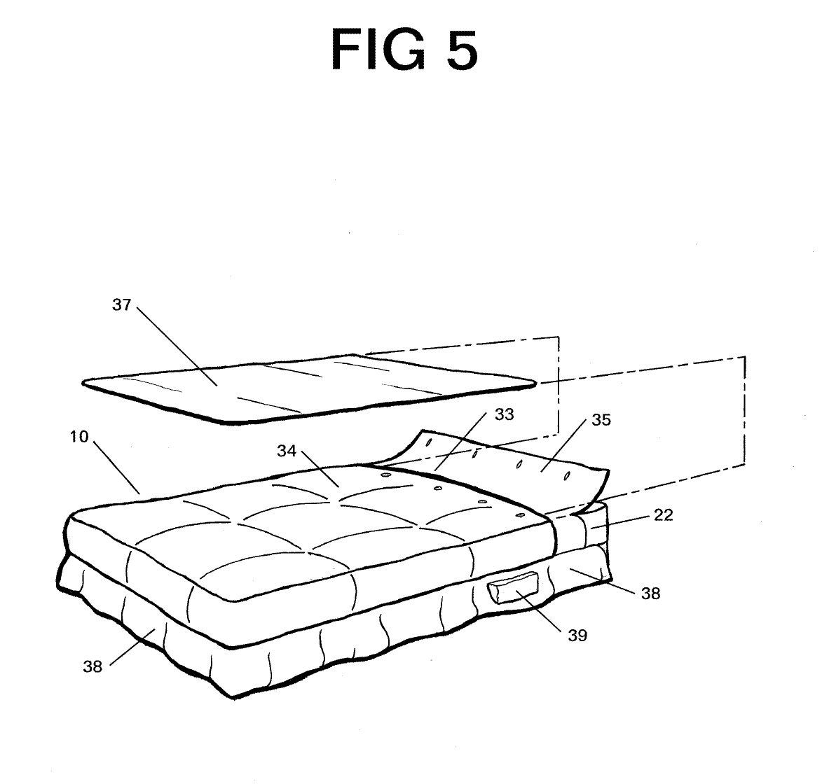

FIG. 5 shows a perspective view of another embodiment of the apparatus 10. In this embodiment of the apparatus 10, the blanket 34 is a duvet with opening 33 configured to allow the insertion of additional bed covering, such as a comforter 37. The opening 33 is created by flap 35 that extends from the blanket 34. As shown, the flap bears fasteners configured to close the opening 33 by securing the flap onto the blanket.

Still referring to FIG. 5, the fasteners are depicted as buttons with matching buttonholes; however, snaps, hook-and-loop, or even a zipper-type of fastener are also suitable to secure the flap. When the flap is secured to the rest of the blanket 34 (and therefore the opening 33 is covered) the embodiment shown in FIG. 5 is analogous to the embodiment shown in FIG. 4. For example, the blanket 34 covers the fitted sheet 22, and edges of the blanket 34 will droop downwardly over the side portions of the mattress. Moreover, a portion of the duvet blanket 34 will also cover the upper hem of the skirt 38, and will also obscure the zipper from view as well. However, the duvet blanket 34 shown in FIG. 5 enables one to create a heavier bed covering by inserting additional material (such as a comforter) for additional warmth.

Although the present invention has been described and illustrated in detail, it is to be clearly understood that the same is by way of illustration and example only, and is not to be taken by way of limitation. The spirit and scope of the present invention are to be limited only by the appended claims that will precisely define the metes and bounds of the invention.

1. A bedding apparatus adapted for use in combination with a mattress, the apparatus comprising:
a fitted sheet having
a central portion configured to cover a top surface of the mattress,
side wall portions configured to cover side portions of the mattress, the side portions of the mattress depending in a general downward direction from the top surface of the mattress and terminating at a lower edge of the mattress;
zipper teeth coupled to the side portion of the fitted sheet;
an edge defining the periphery of the fitted sheet, the edge having a channel containing an elastic band; wherein the edge is configured to engage a lower surface of the mattress;
a skirt attached to side wall portions of the fitted sheet;
a blanket attached to the fitted sheet, the blanket having
a first layer;
a second layer;
a flap extending flora the first layer and configured to extend over an opening formed between the first layer and the second layer;
the blanket also having blanket edge portions defining a perimeter, each blanket edge configured to extend beyond the central portion of the fitted sheet such that at least a portion of the blanket is positioned adjacent the side portions of the mattress when the fitted sheet envelopes the mattress;
zipper teeth positioned on the blanket, the teeth configured to mate with and removably connect the blanket to the fitted sheet; wherein, the blanket is selectively positionable between an unzipped position with the blanket off the fitted sheet and a fully zipped position wherein the blanket covers the fined sheet.

2. (canceled)

3. The bedding apparatus as in claim 1, wherein an upper hem of the skirt is attached adjacent the zipper teeth.

4. The bedding apparatus as in claim 1, wherein the mating portion of the zipper is positioned on the fitted sheet in a location adjacent the lower edge of the mattress.

5. The bedding apparatus as in claim 1, further including at least one pouch positioned on the skirt.

6. The bedding apparatus as in claim 1, the blanket comprising:
fasteners attached to the blanket and configured to secure the flap to the second layer.

7. The bedding apparatus as in claim 6, wherein the fasteners comprise buttons.

8. The bedding apparatus as in claim 6, wherein the fasteners include a zipper.

9. The bedding apparatus as in claim 1, further including bed covering removably insertable between the first layer and the second layer.

10. The bedding apparatus as in claim 1, wherein the first layer is attached to the second layer adjacent the perimeter.

11. A method of providing removable bed covering for a mattress the method including the steps of:
providing a mattress having a top surface, a bottom surface generally parallel the top surface and set apart therefrom by side walls depending downwardly from edges of the top surface;
providing a fitted sheet configured to envelop the top surface and side walls of the mattress, the fitted sheet also having an elastic edge with a channel containing an elastic band; wherein the elastic band is configured to engage a lower surface of the mattress;
attaching a blanket to the fitted sheet, the blanket having blanket edge portions defining a perimeter, the blanket further including a first layer, a second layer, and a flap extending from the first layer and configured to extend over an opening formed between the first layer and the second layer;
configuring each blanket edge to extend beyond the central portion of the fitted sheet such that at least a portion of the blanket is positioned adjacent the side portions of the mattress when the fitted sheet envelopes the mattress;
connecting the blanket to the fitted sheet using a zipper that has an initial portion positioned on side wall portions of the fitted sheet and a mating portion positioned adjacent the blanket edge; and,
attaching a skirt to the side wall portions of the fitted sheet in a location adjacent the lower edge of the mattress.

12. (canceled)

13. The method as in claim 11, further including the step of positioning the initial portion of the zipper adjacent an upper hem of the skirt.

14. The method as in claim 13, wherein the initial portion of the zipper is attached to a side wall portion of the fitted sheet.

15. The method as in claim 11, wherein the mating portion of the zipper is positioned adjacent edges of the blanket.

16. The method as in claim 11, further including the steps of:
attaching fasteners to the blanket to selectively enable the flap to be secured to the second layer.

17. The method as in claim 16, further including the stop of inserting bed covering into the opening.

18. The method as in claim 1, wherein the fasteners comprise at least one of hook and loop fastener;
buttons with mating button holes; and,
a zipper.

19. A bedding apparatus adapted for use in combination with a mattress, the apparatus comprising:
a fitted sheet having
a central portion configured to cover a top surface of the mattress,
side wall portions configured to cover side portions of the mattress, the side portions of the mattress depending in a general downward direction from the top surface of the mattress and terminating at a lower edge of the mattress;
zipper teeth coupled to the side portion of the fitted sheet;
an edge defining the periphery of the fitted sheet, the edge having a channel containing an elastic band; wherein the edge is configured to engage a lower surface of the mattress;
a skirt attached to side portions of the fitted sheet and positioned at a location adjacent the lower edge of the mattress, the skirt having a zipper positioned adjacent an upper hem and the side portion bearing a mating portion of the zipper;
a pouch formed on the skirt;
a blanket attached to the fitted sheet, the blanket having
blanket edge portions defining a perimeter, each blanket edge configured to extend beyond the central portion of the fitted sheet such that at least a portion of the blanket is positioned adjacent the side portions of the mattress when the fitted sheet envelopes the mattress; and
a first layer joined to a second layer at the perimeter, and a flap extending from the first layer and configured to extend over an opening formed between the first layer and the second layer, and fasteners attached to the blanket and configured to secure the flap to the second layer to the first layer;
zipper teeth positioned on the blanket, the teeth configured to mate with and removably connect the blanket to the fitted sheet; wherein, the blanket is selectively positionable between an unzipped position with the blanket off the fitted sheet and a fully zipped position wherein the blanket covers the fitted sheet.
